(19) United States
(12) Patent Application Publication
(10) Pub. No.: US 2005/0257200 A1
(43) Pub. Date: Nov. 17, 2005

(54) Generating code for a configurable microprocessor

(76) Inventor: Richard Michael Taylor, Midlothian (GB)

Correspondence Address: Richard C Woodbridge;Synnestvedt Lechner & Woodbridge, PO Box 592, Princeton, NJ, 08542-0592, US

(21) Appl. No.: 10/518,556

(22) PCT Filed: Jun. 30, 2003
(86) PCT No.: PCT/GB03/02822

§ 371 Date: Dec. 22, 2004

(30) Foreign Application Priority Data
Jun. 28, 2002 (GB) 0215035.7

(51) Int. Cl. G06F 9/45

(52) U.S. Cl. 717/136

(57) ABSTRACT

A process for generating executable code for a configurable microprocessor architecture. The architecture contains registers distributed between execution units under direct software control. A internal representation allows explicit allocation of both register and connectivity resources in the architecture.

### TECHNICAL FIELD

The present invention is in the field of digital computing systems. In particular, it relates to a method for generating executable code for a configurable microprocessor.

### BACKGROUND ART

Most existing modern architectures have a register file centric execution model. Each operation takes register operands and the result is written back into the register file. Each functional unit in the processor has enough access ports to the register file to ensure that it is able to read and write all the required data values to perform the operation. This is highly undesirable from an architectural scalability viewpoint. However, it does mean that the code generator does not have to be concerned with the transport of data values to and from functional units. It only has to perform register allocation and the architecture ensures that there are always sufficient communication resources.

It is desirable from the perspective of efficiency to design a microprocessor architecture to reflect the requirements of a particular application domain. This provides better performance characteristics for a fixed application area. However, such an architecture may have asymmetrical access to the register file. Certain functional units might not have direct access to the register file or the range of accessible registers might be restricted.

The code generator cannot assume the bus network is fully connected or symmetrical. It will have been optimised for a particular application. There may be many routes to transfer a particular data item to a particular functional unit operand. The code generator needs to choose the route that will have the least impact on the routing of other data items.

Transport Triggered Architectures (TTA) must issue explicit operations for all data movements within a system. For an operation to be performed the code generator must ensure that all the required operands are available at the functional unit performing the operation on the required clock cycle. It is possible that an operation cannot performed on a particular clock cycle because this cannot be achieved, even if the operands have been calculated and are present elsewhere within the processor. The code generator for a TTA must be able to handle such cases in order to reliably generate code for the architecture.

Clustered architectures contain a number of separate registers files. Only a subset of functional units may access each of the dusters. If data needs to be transferred between clusters then an explicit transfer operation must be issued. The code generation process must ensure that the number of such explicit transfers are minimised.

### SUMMARY OF INVENTION

A code generation system is provided that is able to read a description of a particular configured microprocessor architecture. This description contains information about the number and type of execution resources that are available and the connectivity between those resources. The code generator is then able to map a software program (in an architecture independent intermediate form) onto the target architecture. The code generator seeks to make best use of the resources available in order to exploit instruction level parallelism available in the input code.

The code generator generates a graph representation of the data and control flow within a particular block of code. The graph explicitly represents all the data transfers and internal register dependencies on the architecture being targeted. Critical path analysis is applied to the graph to determine the most performance critical operations in the graph. The most critical operations are then scheduled first so that they are given the best choices of communication routes in the architecture. This is because delays on these operations will have the most impact on overall code performance.

A unit allocation step binds individual operations in the input program onto physical execution resources available in the target architecture. A transport allocation step binds individual data flows between operations onto communication resources within the target architecture. A transport optimisation step rewrites the graph representation to reduce the number of uses of a central register file in the architecture. This step also finds improved paths for the transfer of data between execution units in the architecture to provide greater opportunities for execution parallelism. An execution word creation step optimises the encoding of instructions on the target architecture. Finally, a scheduling step maps the graph representation onto an efficient sequence of instructions on the target architecture.

### BRIEF DESCRIPTION OF THE DRAWINGS

FIG. 1 illustrates how the execution word of the processor is used to control the operand multiplexers of the functional units and thus control data flow in the system.

FIG. 2 shows an example allocation of the execution word to various functional units within the architecture.

FIG. 3 shows the internal flow of steps required to generate code.

FIG. 4 shows a representation of a node in the graph.

FIG. 5 shows an example Control and Data Flow Graph.

FIG. 6 shows an example Control and Data Flow Graph that includes two different strands.

FIG. 7 shows a representation of a node in a Control and Data Flow Graph and illustrates the information that is included in the representation.

FIG. 8 illustrates the dependencies between different strands that are present in order to enforce the phasing of strands.

FIG. 9 shows a first example of how the contention set of a given node in the Control and Data Flow Graph is used to drive selection of a node allocation.

FIG. 10 shows a second example of how the contention set of a given node in the Control and Data Flow Graph is used to drive selection of a node allocation.

FIG. 11 shows a first example how the allocation of nodes in the Control and Data Flow Graph relates to the logical layout of functional units.

FIG. 12 shows a second example how the allocation of nodes in the Control and Data Flow Graph relates to the logical layout of functional units.

FIG. 13 shows a solution for eliminating a register write and read pair that is more efficient than that shown in FIG. 27.

FIG. 14 shows how ordering dependencies are represented between writes to a particular register resource.

FIG. 15 shows how ordering dependencies are represented between reads and writes to a particular register resource.

FIG. 16 shows how writes and reads to the same register within the same strand are connected to allow subsequent optimisation.

FIG. 17 shows how a single register read may receive data that is a confluence from multiple potential write sources.

FIG. 18 shows how an edge to the sink node is used to represent registers that are live outside of the region.

FIG. 19 shows an example of the insertion of copy nodes in a Control and Data Flow Graph for an architecture with particular connectivity.

FIG. 20 shows how copies may be inserted into the Control and Data Flow Graph as it is being constructed.

FIG. 21 shows how a Control and Data Flow Graph can be rewritten to avoid an unnecessary register file read operation.

FIG. 22 shows how a Control and Data Flow Graph can be rewritten to avoid both a register write and a register read.

FIG. 23 shows how a new use of an output register can be inserted into the live range of that register and appropriate dependencies added.

FIG. 24 shows an architecture used in a transport optimisation example.

FIG. 25 shows the process of eliminating a register write and read pair in an example graph.

FIG. 26 shows one possible option for eliminating a register write and read pair that leads to a cycle graph.

FIG. 27 shows a valid solution for eliminating a register write and read pair.

### DESCRIPTION OF PRESENTLY PREFERRED EMBODIMENT

One of the key requirements of the architecture is to support scalable parallelism. The structure of the target architecture is focused on that goal. The code generation must read a description of a configured architecture and efficiently map code for execution upon it. Potential opportunities for instruction level parallelism must be identified in the input program and the resources of the target architecture utilised efficiently to make use of that potential parallelism

Extracting parallelism from highly numeric loop kernels is relatively straightforward. Such loops have regular computation and access patterns that are easy to analyse. The nature of the algorithms also tends to lend itself well to parallel computation. The architecture just needs to balance the availability of computational resources (such as adders, multipliers) and memory units to ensure the right degree of parallelism can be extracted. Such numeric kernels are common for Digital Signal Processors (DSPs). The loops tend to lack any complex control flow. Thus DSPs tend to be highly efficient at regular computation loops but are very poor at handling code with more complicated control flow.

Other than in numeric computation loops, C and C++ code tends to be filled with complicated control flow structures. This is simply because most control code is filled with conditional statements and short loops. Most C++ code is also filled with references to main memory via pointers. The result is a code stream from which it is extremely difficult to extract useful amounts of parallelism. In average Reduce Instruction Set Computer (RISC) code, approximately 30% of all instructions are memory references and a branch is encountered every 5 instructions.

The control and complexity overheads of dynamic out-of-order execution are far too high for the application domain of the preferred embodiment of embedded systems. There is a significant cost overhead due to the area occupied by the control logic, not to mention the cost of designing it. Additionally, such logic is not amenable to the scalability requirements of the preferred embodiment.

A number of recent developments in the area of micro architecture have been focused on VLIW type architectures. There is a “back to basics” movement that seeks to place the burden of extracting parallelism on the compiler. The compiler is able to perform much greater analysis to seek parallelism in the application. It is also considerably simpler to develop than equivalent control logic. This is because the equivalent control logic must find the parallelism as the program is running, and so must itself be highly pipelined and suffers from the physical constraints of circuit design. The compiler performs all of its work up front in software with the luxury of much longer analysis time. For most classes of static parallelism, compiler analysis is very effective.

Unfortunately, software analysis is poor at extracting parallelism that can only be determined dynamically. Examples of these are branches and potentially aliased memory accesses. A compiler can know the probability that a particular branch will be taken from profiling information, but it cannot know for sure whether it will be taken on any particular instance. A compiler can also tell from profiling that two memory accesses never seem to access the same memory location, but it cannot prove that will always be the case. Profiling is a method used to extract information about the dynamic behaviour of a program by instrumenting it during its execution. Consequently it is not able to move a store operation over a potentially aliased load operation as that might affect the results the program would generate. This restricts the amount of parallelism that can be extracted statically in comparison to that available dynamically.

The preferred embodiment employs a unique combination of static and dynamic parallelism extraction. This gives the architecture access to high degrees of parallelism without the overhead of complex hardware control structures. The instructions may be out of order with respect to the original program, if the tools are able to prove that the re-ordering does not affect the program result. This re-ordering is called instruction scheduling and is an important optimisation pass for most architectures, and especially for the preferred embodiment.

Communication Architecture

Although the preferred embodiment architecture does have a central register file it is treated like any other functional unit. All accesses to the register file have to be explicitly scheduled as separate operations. Since the register file acts like any other functional unit its bandwidth is limited. The code is constructed so that the majority of data values are communicated directly between functional units without being written to the register file.

Traditional architectures have a centralised register file that has customized access ports to all of the functional units. Access to the register file is implicit in the instruction layout and semantics of the instruction set The register file is used to feed the operands of the execution units and hold the results generated by them. Unfortunately such a centralised register file imposes a significant restriction on scalability. As the level of parallelism in the instruction stream increases so does the number of access ports required on a centralised register file. These are needed to provide operands to and write back results from all the active execution units. The register file soon becomes the bottleneck in the design and starts to have a strongly detrimental affect on the maximum clock speed.

Given the requirement to make the architecture highly scalable, communication of all data through a centralised register file is not a viable architectural option. Whenever a functional unit generates a result it is held in an output register until explicitly overwritten by a subsequent operation issued to the unit. During this time the functional unit to which the result is connected may read it.

A single functional unit may have multiple output registers. Each of these is connected to a different functional unit or functional unit operand. The output registers that are overwritten by a new result from a functional unit are programmed as part of the execution word. This allows the functional unit to be utilised even if the value from a particular output register has yet to be used. It would be highly inefficient to leave an entire functional unit idle just to preserve the result latched on its output. In effect each functional unit has a small, dedicated, output register file associated with it to preserve its results.

Given the connectivity limitations of the functional unit array, not every unit is connected to every other. Thus in some circumstances a data item may be generated by one unit and needs to be transported to another unit with which there is no direct connection. The placement of the units and the connections between them is specifically designed to minimise the number of occasions on which this occurs. The interconnection network is optimised for the data flow that is characteristic of the required application code.

To allow the transport of such data items, any functional unit may act as a repeater. That is it may select one of its operands and simply copy it to its output without any modification of the data. Thus a particular value may be transmitted to any operand of a particular unit by using functional units in repeater mode. A number of individual “hops” between functional units may have to be made to reach a particular destination. Moreover, there may be several routes to the same destination. The code generator selects the most appropriate route depending upon other operations being performed in parallel.

There are underlying rules that govern how functional units can be connected together. Local connections are primarily driven by the predominant data flows between the units. Higher level rules ensure that all operands and results in the functional unit array are fully reachable. That is, any result can reach any operand via a path through the array using units as repeaters where needed. These rules ensure that any code sequence involving the functional units can be generated. The performance of the code generated will obviously depend on how well the data flows match the general characteristics of the application. Code that represents a poor match will require much more use of repeating through the array.

Instruction Representation

The preferred embodiment is a Very Large Execution word (W) format This enables many parallel operations to be initiated on a single clock cycle, enabling significant parallelism. The actual width is not fixed by the architecture and is under user control. Shorter widths tend to be more efficient in terms of code density but poorer in extracting parallelism from the application.

The instruction format is not fixed either and is dependent upon the execution units the user defines for a particular processor. Unlike many contemporary VLIW architectures, the architecture uses a simpler flat decode structure. This means that a particular execution unit is always controlled from a specific group of bits in the execution word. This makes the instruction decoding for the architecture very straightforward. High end VLIW architectures tend to bundle a number of independent operations into a single execution word As a result they still require quite complex decode logic to direct different operations to the appropriate execution units.

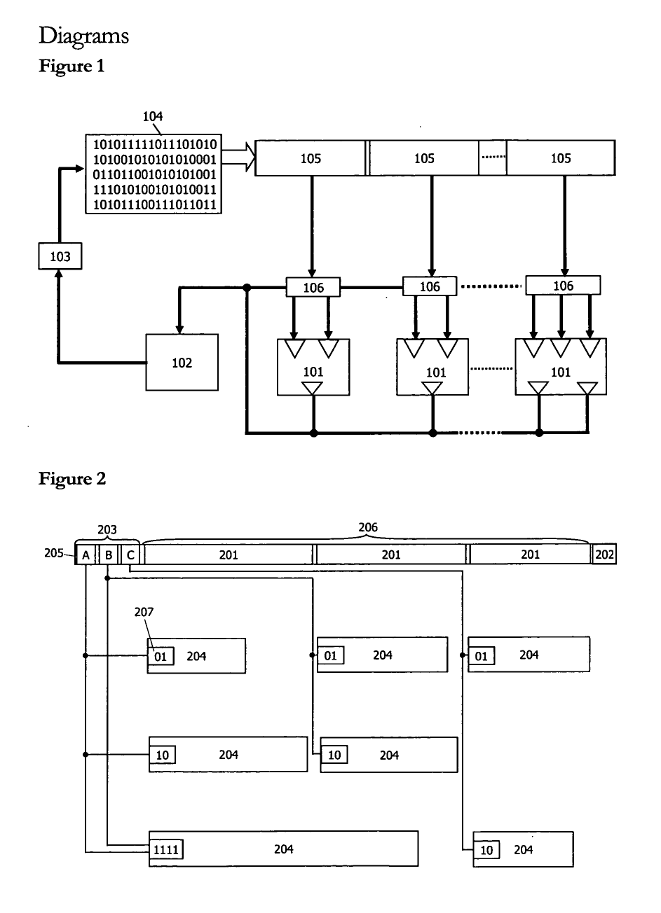

FIG. 1 illustrates the basic instruction decode and control paths of the preferred embodiment processor. The instruction memory 104 holds the representation of the operations in the customized format for the processor. A new execution word is fetched on each clock cycle. Each block of bits 105 in the execution word is used for controlling a particular execution unit 101. The bits in the execution word are used to control multiplexers 106 that direct data from the interconnection network to the operand inputs of the execution unit. Results from the execution units are routed back to the interconnection network to be used by subsequent operations. A branch unit 102 is used to perform branches that modify the program counter 103 in order to change the sequence of execution words being fetched.

The figure represents a simplification of how the architecture actually operates but demonstrates the key features. In particular, the execution word layout is not completely flat. If it were then the width of the execution word would grow with the number of execution units in the system, potentially reaching unwieldy widths. The representation would also be highly inefficient as a number of execution units will generally be unused on each cycle, and thus the bits controlling them would be wasted.

Strand Execution Model

One of the central innovations of the architecture is its “strand” based execution mechanism. These are rather like threads but represent a much lower level construct that is present in the architecture to support out-of-order execution.

A strand represents a particular sequential group of operations that is being executed on the machine. Many strands may be executed simultaneously. Each individual operation that is performed belongs to a particular strand. Each execution word is executed it may contain operations that associated with a number of different strands.

This mechanism allows instructions to be issued out of order. However, if the correct results are to be produced by the architecture then the data flows between strands that would occur if they were executed in the correct order must be maintained.

The code generation process of the preferred embodiment can determine the correct ordering of most operations statically. The main exception to this is memory operations, where the addresses cannot be determined at compile time.

Region Based Execution

In the preferred embodiment all execution is performed within blocks of code called regions. A region is a block of code that only has a single entry point but potentially many exit points. The analysis performed by the preferred embodiment is used to form groups of basic blocks into regions. In the preferred embodiment, regions are always completely executed. If the region contains a number of internal branches to basic blocks outside of the region then they are not resolved until the end of the region reached The code generator constructs the regions from basic blocks so that they contain the most likely execution paths through the basic blocks. A region is able to perform a multi-way branch to select one of a number of different successor regions.

All strands are limited to the lifetime of a single region. The architecture is able to execute operations out of order within a particular region. Out of order execution and any resulting hazards are resolved at the end of the region and then execution continues on to another region, which may itself issue operations out of order.

If a hazard is detected during execution then the sequential semantics of the strands have not been properly preserved. The architecture must be able to recover from this situation with as little overhead as possible.

Upon detecting a hazard in a particular strand the results generated for that and any later (i.e. higher numbered) strands may be incorrect. The architecture allows execution to continue until the end of the region, when the strands will be completed. Any results from the hazard, and any higher, strands are discarded. The architecture then re-executes the code from the start of the region again. Since lower numbered strands have already been successfully completed they are not executed a second time. The architecture includes logic to block operations from those strands. Since the lower strands have completed and generated their results the hazard strand is able to execute correctly, utilizing any required results from the lower strands. If another, even higher numbered, strand generates a hazard then the region may be repeated a second time. When all strands have successfully completed the processor may move onto the successor region.

The goal of the preferred embodiment is to execute all strands successfully on the first attempt. The compiler does extensive analysis to ensure that the chances of hazards are small. The key is that the compiler doesn't have to prove that a hazard cannot happen. The re-execution mechanism will ensure correct completion of the strands if required. It does this with a minimum of hardware overhead. The size of regions is limited to a few tens of instructions so that the overhead of any re-execution of the region is not too great.

Code Generation

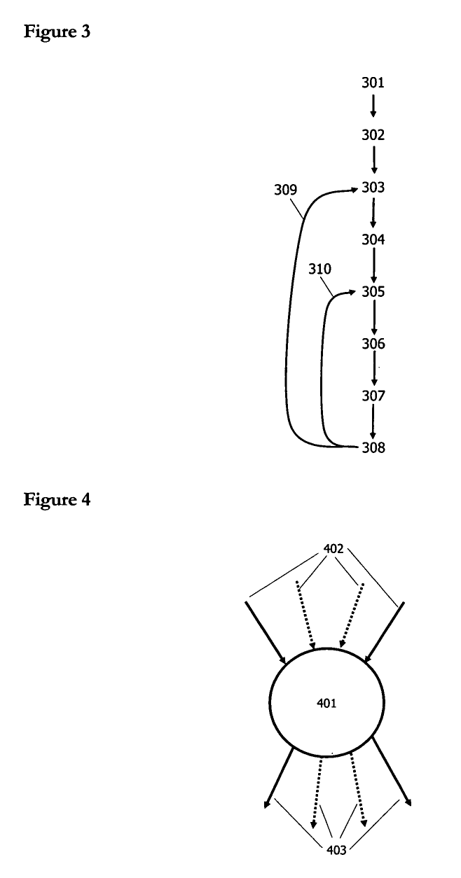

FIG. 3 shows the flow of individual steps involved with the code generation process. This flow assumes that the input form of the code is an executable image. However, those skilled in the art will recognize that these steps may constitute the final stages of a complete compilation process from a high level language. Step 301 represents a control flow analysis of the functions which are to be mapped to the processor. This determines the relationships between basic blocks in the code. Step 302 is a liveness analysis of the registers within the functions that are to be mapped. This is used to drive the subsequent code translation process depending on the liveness of results from particular instructions.

The following steps iterate 309 over all of the functions in the input code that are to be mapped to the architecture. Step 303 is a code translation that converts input instructions into a sequence of operations that are represented in a graph form. This step also subdivides the functions into a number of individual regions. Step 304 represents the construction of an idealized graph. This optimizes the graph on the basis that all required connectivity will be available in the architecture. This is subsequently used to drive the unit allocation step.

The following steps iterate 310 over all of the regions associated with a particular function. Note that iteration is nested within the outer iteration 309 across all functions. Step 305 performs an allocating of operations within the graph to particular functional units within the architecture. Step 306 performs a transport allocation to bind data flows to particular connection resources within the architecture. Step 307 performs a transport optimization to make efficient use of additional connectivity resources that may be present in the architecture. Step 308 performs a code scheduling of the graph onto the architecture.

Once the architecture has been fixed and new code is to be targeted to a processor then only the code generation process needs to be performed. The code generation process described here may be used as a fitness measurement method for a given candidate architecture.

Idealised Code Representation (Step 303)

In the preferred embodiment this step involves creating a Control and Data Flow Graph (CDFG) by translating the relevant code from the host executable image. An idealised CDFG does not include many of the explicit register file read and write operations that are required to access items from the register file. An idealised CDFG assumes that data can flow directly from one operation to the next without needing to be written to the register file. Since this implies complete connectivity between all functional units, this idealised CDFG representation cannot be used for final code generation but it does allow the predominant data flows in the code to be captured. An idealised CDFG also avoids dependency arcs between potentially aliased memory accesses. They are still generated for definitely aliased accesses. Thus the CDFG and data flow is not unnecessarily serialised by the existence of potential memory hazards.

An idealised CDFG is constructed as a first step in order to drive the next stage of unit allocation. To work efficiently the unit allocation needs to know the units from which operands are obtained and to which results are ultimately transported. This information is obfuscated in a non-idealised and unoptimised CDFG as most accesses will be to the register file. By using information about the data flow the unit allocation can make efficient choices about which unit to allocate a particular operation to if there is a choice of multiple units. The underlying assumption is that the majority of optimisations introduced in the CDFG by its idealised creation will ultimately be available by applying subsequent transport optimisations on an unoptimised CDFG.

Unit Allocation (Step 305)

The purpose of the unit allocation is to fix the physical functional unit that will perform each operation in the CDFG. Where there is only a single functional unit of the required type for an operation available this process is obviously trivial. However, in order to exploit parallelism in the code, in many cases there will be a set of functional units of the same type from which to choose. The unit allocation must both balance the usage of all the functional units and make spatially sensible choices so that units are used that are dose to the functional units that generate the input operands required and dose to the units that will ultimately consume the results. Making such selections minimises the overhead and latency introduced by having to transport data between functional units via copy operations. The unit allocation makes selections based on the data flows in the idealised CDFG so that accesses to the register file do not hide the true source and destination of particular data items.

Transport Allocation (Step 306)

During this step allocation of data flows to physical connectivity within the architecture is performed. All data arcs within the CDFG are visited. If there is a physical bus corresponding to the data flow representing the arc then the arc is directly allocated to the bus and the output register associated with the connection. Suitable ordering arcs are added to the CDFG to ensure that the value in the register is present when the consuming operations are scheduled. If there is no direct connection associated with the data arc then additional copy nodes may be inserted into the graph to transport the data value around the functional unit network as required. This involves the addition of multiple ordering arcs to constrain the register flow.

Transport Optimisation (Step 307)

During this phase the default transports allocated during the transport allocation step are optimised. The initial usage of default routes for transports results in unnecessary serialisation of particular operations that share elements of their transport routes. This reduces the amount of parallelism available and degrades overall performance.

The purpose of the transport optimisation phase is to improve the transport operations around the nodes in the CDFG in the order of their overall criticality. Thus the more critical operations are given the widest choice of alternative transport routes. The CDFG is rewritten to utilise more direct or efficient transport routes where possible. The transport optimisation phase is also responsible for generating and storing requests for new connections between functional units in the architecture. These connection requests are used during the architectural optimisation to select addition physical connections to be added to the architecture.

Operation Scheduling (Step 308)

The main operation scheduling maps the optimised CDFG onto the architecture. This generates the actual microcode for the application.

Control/Data Flow Graph Representation

The Control and Data Flow Graph (CDFG) is a core representation used in the preferred embodiment. It is used to represent both the control and data flow of a sequence of code.

The graph is constructed by analyzing host machine code. The graph representation elicits the data flow between operations and their other dependencies. The representation allows the ordering and timing constraints of operations to be shown while avoiding unnecessary restrictions on the ordering of operations.

The CDFG is a Directed Acyclic Graph (DAG). A CDFG is constructed for each region being translated. The graph construction must ensure that its acyclic property is maintained, as the scheduler is unable to generate code sequences for cyclic graphs. The nature of code data and control flow is such that this is relatively easy to achieve. Loops in the control flow are not represented within a region itself but by a branch to the start of the region containing the loop. This branch is considered to be external to the region and, as such, does not require a cyclic arc in the graph.

The fundamental component of the CDFG is the node. This is illustrated in FIG. 4. An operation node 401 has a number of associated attributes that describe the operation to be performed. Each node also has a number of inflow 402 and outflow 403 arcs. A node must have at least one inflow arc and one outflow arc. The only exceptions are the source and sink nodes at the start and end of the CDFG, respectively.

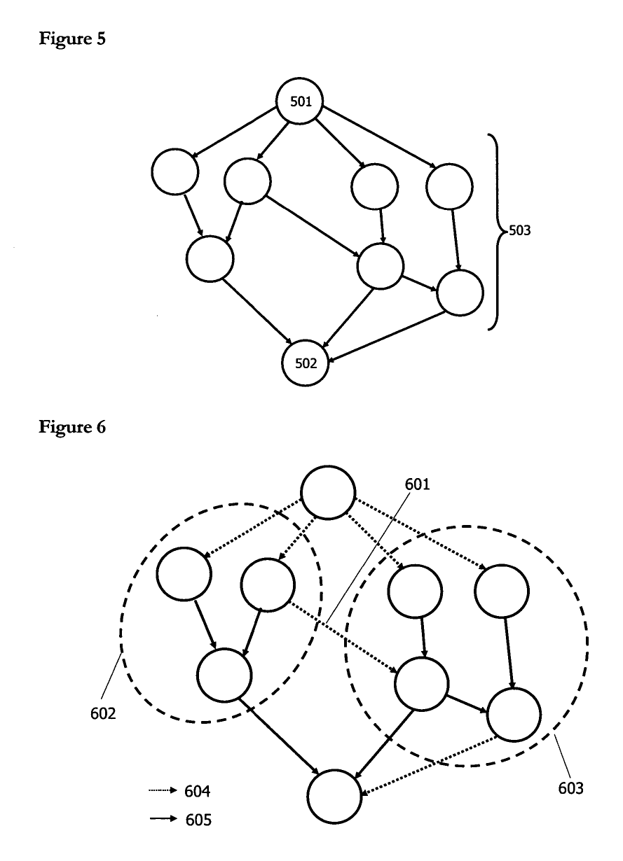

FIG. 5 shows the structure of a typical CDFG. The node 501 is the source node for the CDFG. There are various operation nodes 503 that are generated as part of the translation process. There are various dependencies between those nodes that show the ordering constraints between them. Finally, there is a sink node 502 representing the end of the CDFG.

Operation scheduling is performed from the end of the CDFG (i.e. the sink node) to the source node. A given node cannot be issued in the schedule until all its dependent nodes have been issued. The node can then be issued earlier in the schedule than the earliest of its dependents. This is a depth first traversal of the CDFG.

The following describes the various types of nodes and arcs that may appear in a CDFG:

Node Types

Source Node

The source node is the very first node in the CDFG. It has no inflow arcs. It is a virtual node only present to allow easy traversal of the CDFG. It does not result in an operation being generated in the final code sequence.

Operation Nodes

Operation nodes are generated as part of the translated process. Each operation node has various attributes associated with the operation that it represents. These are dependent upon the type of operation. However, all operations have an associated functional unit type and method. These show which particular type of unit will execute the operation and the particular method to be used.

Sink Node

The sink node is the very last node in the CDFG. It has no outflow arcs. It is a virtual node only present to allow easy traversal of the CDFG. It does not result in an operation being generated in the final code sequence.

Arc Types

Data Arcs

A data arc represents the flow of data from the result of one operation to the operand of another. The transport allocator must examine each of the data flows represented by a data arc and arrange suitable transport of the data item from the generating unit to the consuming unit. The existence of a data arc between two operations guarantees that a physical data path exists between them if the CDFG is concrete. Data arcs within idealised CDFGs do not necessarily correspond to real connectivity.

Each data arc is annotated with a latency value. This represents the number of clock cycles between issuing the generating operation and the result becoming available. The scheduler ensures that sufficient distance is placed between the two operations that the result will be available. Moreover, the scheduler must ensure that the result is read before being overwritten by a subsequent operation issued to the same generating unit.

Control Arcs

A control arc represents an ordering constraint between two nodes in the CDFG. The dependent node cannot be issued before the dependee node. Control arcs are used to represent various scheduling constraints that are not associated with data flow. For instance, control arcs are generated between certain load and store memory operations whose ordering cannot be changed without affecting the program results.

Each control arc is annotated with a minimum distance value. This is the minimum number of clock cycles that must separate the two operations. A distance of 0 indicates that they can be issued on the same clock cycle.

Tunnel Arcs

A tunnel arc forces a particular ordering between operations. A tunnel arc is used as an indicator to the transport optimiser that the control arc is present because of a data item “tunneling” through the register file or memory. The data flow is not explicit but, instead, is stored in the internal state of the register file or memory unit. For instance, if a data item is written to a particular register and subsequently read by a later operation then a tunnel arc may be generated between the two operations. This indicates that a data item is being transferred between them and thus the read cannot happen until after the write is completed.

The CDFG optimiser may rewrite the CDFG surrounding a tunnel arc to provide a direct and explicit transfer of a data item if there is no particular reason why the register file or memory unit needs to be used. This forms part of the process of eliminating unnecessary register file accesses if data cannot be transferred directly between functional units.

Each tunnel arc is annotated with a minimum distance value. This is the minimum number of clock cycles that must separate the two operations. A distance of 0 indicates that they can be issued on the same clock cycle.

Strand Representation

Each region is composed of a number of strands. All operations are a member of one particular strand. Strands are used to separate operations that belong to different control flow paths in the region. In general, strands correspond to basic blocks.

FIG. 6 illustrates a CDFG containing two different strands 602 and 603. Both data arcs 605 and control arcs are shown. In general the data flow within a particular strand must be self-contained. Generally only control arc 601 relations are present between strands. This is because on any given execution of the region certain strands may be disabled. Thus a later strand may read an undefined value since the earlier strand will not have calculated the data item. Communication between the strands occurs through the register file and memory. All registers that are live at the end of a strand in the host code are written to the register file in the translated code. Thus subsequent strands can read the data values via the register file.

Node Creation

As instructions are translated, new operations are added to the CDFG. A single node in the CDFG represents each operation. A method for adding a new operation is identical for all types of operations. The new node has to be connected appropriately to other nodes in the CDFG to show the data flow and constraints on the ordering of operations.

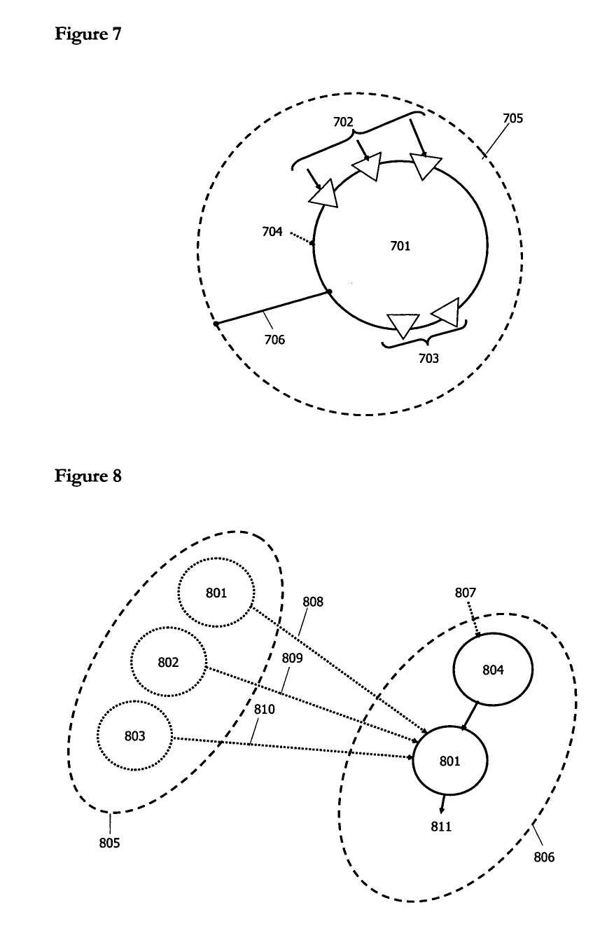

FIG. 7 illustrates the arc connectivity associated with a new node. A new node 701 has a number of associated attributes that are dependent upon the type of operation that the node represents. All operation nodes have an associated functional unit and method indicating how the operation is to be performed on the hardware. Squash operations also have an attribute of the strands that they control.

Each new operation is associated 706 with a particular strand 705. The link to the parent strand is used when generating the final code to determine the strand number to be associated with the operation.

An operation has a number of input data operands 702. Each of these may have parameterised data widths. A data flow arc is connected to the preceding operation that generates data for the operand. In this manner the data flow in the program is elucidated Each data arc is annotated with the latency of the functional unit that is to calculate the value. This is used by subsequent critical path analysis of the CDFG to help determine the best order to issue operations in.

If the operation cannot be performed speculatively then a control arc 704 is generated form the commit operation for the current strand. This ensures that the operation cannot be issued before the commit and thus must be issued in the committed phase of the strand. Such operations may permanently change the state of the machine (such as register writes and memory stores) and cannot be executed before it is certain that the strand is going to be completed.

The operation output ports are subsequently connected to one or more operations that use the result. Results from an operation 703 do not have to be used, in which case no data arc is connected to the result port. However, each operation must have at least one successor arc. This can be to the CDFG sink node if required.

Strand Creation

This section describes the additional operations nodes that need to be added to the CDFG whenever a new strand is started. New strands may be started for a number of reasons but their initiation is normally associated with the start of a new basic block in the translation. The strand mechanism allows multiple basic blocks to be represented in a single region and to be optimised and scheduled as a single entity.

FIG. 8 shows the additional operations created at the start of a new strand 806. An existing strand 805 is present which contains a commit operation 801, a squash operation 802 and a branch operation 803. Two operations 801 and 804 are created in the new strand. Potentially, there is a guard operation 804 to act as a sentinel for entry to the committed phase of the strand. The guard operation is a conditional node and is only actually issued if a weak arc dependency between an operation in the strand, and some preceding strand, is violated. The node may have conditional arcs 807 to operations in preceding strands. Secondly, a commit operation 801 is issued in the new strand 806. The commit operation represents the phase transition barrier between the speculative and committed phases of the strand. The commit node has arcs 811 to all operations in the strand which must only be issued in the committed phase of the strand.

Arc 808 represents an ordering of all commits in strands. Arc 809 represents the dependency between an earlier squash 802 and its impact on the subsequent strand 806. There may be a number of these squashes if the new strand is in a nested control flow area. The arc ensures that all potential squashes associated with the strand are evaluated before the committed phase of the strand is entered. Arc 810 represents the dependency between an earlier branch 803 and its impact on the subsequent strand 806. This is present because a branch from an earlier strand will automatically squash subsequent strands.

All operations that cannot be issued speculatively within the new strand have a control flow arc connecting them to the commit operation. This ensures that they are not issued before the commit phase is entered. Other operations do not have this dependency and migrate to earlier then the commit operation in the schedule and become speculative.

Register Writes

This section describes the representation of the dependencies between writes in the CDFG. Whenever Arcs are generated to the preceding writes to the same register as detailed in FIG. 14. There is a register write 1403 in a first strand 1401. There are also subsequent writes to the same register 1403 in a later strand 1402. There may be intervening operations 1404 in the strand that do not impact the register value. Control arcs serialize the write operations to the same register. Within the same strand, control arcs 1405 are always used. Dependencies between strands use control arcs 1406 if a critical function is being translated. However, in other circumstances a weak arc may be used with a conditional arc to the guard of the later strand. This causes the later strand to be executed during a subsequent region re-execution if the dependencies are violated.

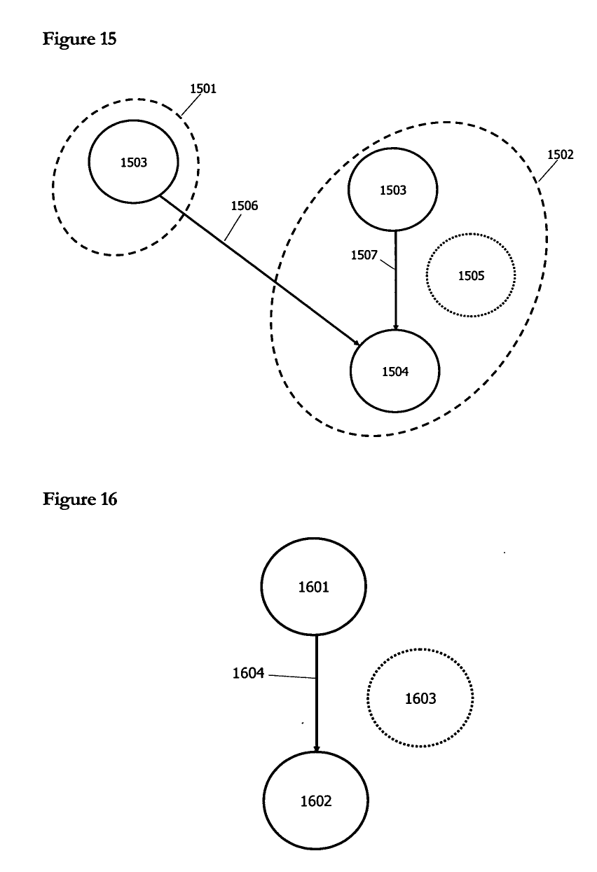

Arcs are generated to the preceding reads of the same register as illustrated in FIG. 15. These arcs ensure that a write to a register is not performed until all reads of the previous value in the register have been completed. A register read 1503 is present in a first strand 1501. A subsequent read to the same register 1503 is also present in a subsequent strand 1502. The strand also contains a register write 1504 to the same register. There may be intervening operations 1505 that are not related to the register. Individual arcs are created from each read to the subsequent write. This avoids serialization of the reads themselves, which can be freely reordering. Within the same strand control arcs 1507 are always used. Dependencies between strands use control arcs 1506 if a critical function is being translated. However, in other circumstances a weak arc may be used with a conditional arc to the guard of the later strand. This causes the later strand to be executed during a subsequent region re-execution if the dependencies are violated.

Register Reads

This section describes the representation of dependencies between register reads in the CDFG. When a read operation is generated an arc is generated to any preceding write to the same register, as illustrated in FIG. 16. Operation 1601 is a write to a particular register and operation 1602 is a read from it. There may be intervening operations 1603 that are not related to the register. If there is no preceding write (i.e. the read is using a value stored in a previous region) then no arc is generated. If there is a single reaching write then a tunnel arc 1604 is generated to it. A tunnel arc indicates that data is being “tunneled” through the register file from the write to the read. The arc acts as a control flow arc in terms of maintaining dependencies but is a hint to the CDFG optimiser that the write and read could be eliminated in some circumstances and the tunneled data made explicit as a data flow arc. The register write may be in a previous strand.

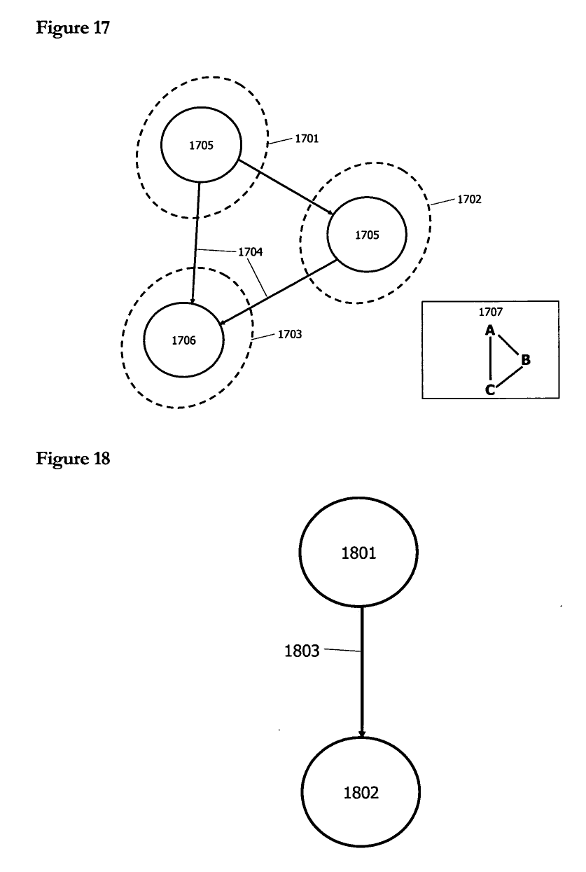

In some circumstances there may be multiple reaching writes for a register. This can happen when there is a confluence of multiply control flow paths, as illustrated in FIG. 17. The diagram shows an IF-THEN construct where a particular register is written before the IF and in the THEN branch. There control flow relationships are shown in 1707. Two register writes 1705 are present in two strands 1701 and 1702. If a read 1706 is subsequently performed in a later strand 1703 then the data could be generated by either of the register writes. In this case control flow arcs 1704 are generated to the list of reaching write operations. A tunnel arc is not generated, as this construct is not amenable to subsequent transport optimisation.

Externally Live Registers

If a particular register is live at the end of a strand then the written value must be maintained in the register. This is because it may be used during the execution of a subsequent region. The register liveness is determined from the full liveness analysis performed on the function being translated.

An externally live register has a tunnel arc generated to the sink node of the CDFG as illustrated in FIG. 18. This tunnel arc 1803 indicates that the sink 1802 (in effect the following regions) use the register value defined by the register write 1801 and it cannot be optimised away. The existence of the arc prevents the CDFG optimiser from removing the register write if it can rewrite the CDFG to use direct data flow.

Note that the same register can be “sunk” to the sink node several times in the same region. This is because different values of the register can be live at the end of different strands within the region.

Unit Allocation (Step 305)

The unit allocation operates an idealised CDFG generated in the previous step. The purpose of this stage is to allocate concrete units where operations are being performed that could be executed by a number of different units.

Each node in the CDFG is visited. If only a single unit can perform the node operation then the selection process simply selects that unit. A concrete unit is then allocated to all other nodes. The ordering is based on the number of nodes of the same type that are predecessors or successors of the nodes in the graph. The nodes with the greatest number of such predecessors/successors are processed first. This ensures that the nodes that will have the most influence on the allocation of other nodes are handled earlier. If a particular use of the unit is intrinsically ordered by the existing data flows in the graph then no subsequent latency adjustments need to be made when trying to allocate the same unit

The unit allocations are remembered in terms of the sequence order that the operations were added to the graph. These are then used during the transported CDFG construction to allocate the correct units.

Conflict Adjustment

The purpose of the conflict adjustment is to measure whether there is a potential for the same unit to be required in parallel with the candidate allocation being tested. Uses of the unit that are definitely before or after the current allocation (as determined by the graph dependencies) do not impact the usage of the unit. However, if the unit may be used in a section of the CDFG that could be scheduled in parallel with the candidate usage then that could impact parallelism. If the potentially parallel nodes were to be allocated to different units then they could potentially be issued on the same cycle. If they are allocated the same unit then that is not possible. The purpose of the conflict adjustment is to modify the latencies within the CDFG to reflect this possible degradation in parallelism. The allocation that maximises the chances of parallelism is then selected.

Selection is based on an augmented graph height analysis. Each possible unit is selected in turn and the resultant graph height calculated. The unit giving the lowest graph height is selected. If there are multiple units resulting in the same graph height then the lowest numbered unit is chosen. The output latencies for the selected node are adjusted to account for potential serialisation caused by use of the same unit. This adjustment factor is based on the number of uses of the same unit in the graph that are not forced predecessors or successors on the basis of the graph dependencies (determined from a transitive closure of the CDFG). The adjustment is the blockage of the unit multiplied by the number of such potentially parallel uses of the unit This mechanism thus adds an extra delay where parallelism may be restricted by the use of the same unit. This methodology tends to allocate different units for calculations that can be performed in parallel according to the idealised dataflow graph.

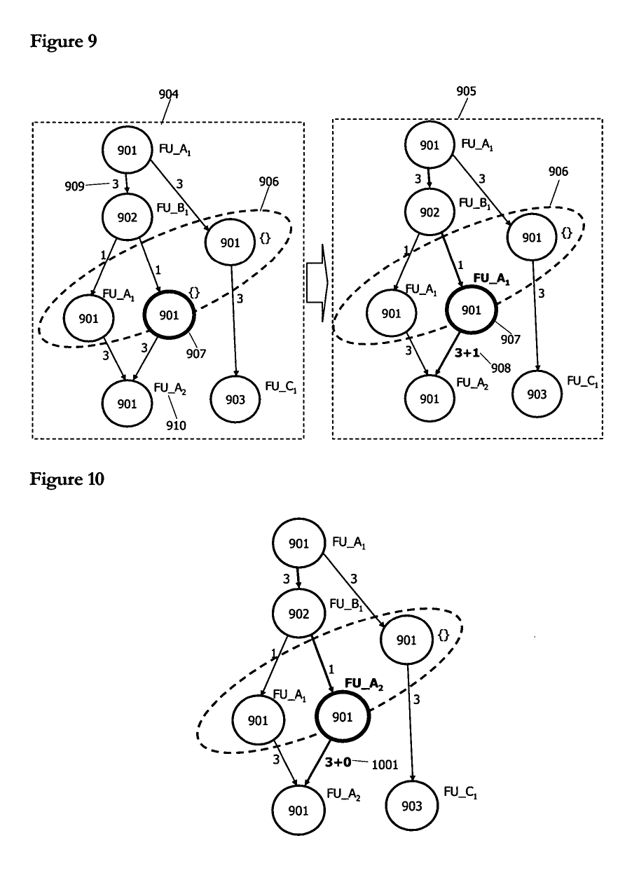

FIG. 9 shows the modifications performed to the CDFG on the basis of unit contention. The original CDFG is shown as 904. The CDFG consists of nodes 901 using unit type A, nodes 902 using type B and units 903 using type C. The allocation to particular units is shown 910. The latencies 909 of data flows between nodes in the graph is also shown. The node 907 is the one for which unit allocation is being performed. The area 906 represents the contention set for the node. These are all the nodes of the same type (and could thus be allocated to the same unit) that are parallel to the candidate node in the CDFG. That is, depending upon the schedule produced, those operations could be issued in parallel to the candidate node. There are two other operations of type A in the contention set. One is currently unallocated to a unit (and thus ignored) while the other has already been allocated to FU_A₁.

In the first allocation attempt 905 the first unit of type A (FU_A₁) is allocated. Since the unit is used in the contention set an additional latency of 1 is added 908 to the output arcs of the candidate node. This represents the blockage of the unit and thus the potential delay caused by serlisation with the existing allocation. When the graph height analysis is performed the total height is 8.

The next step is to try a different allocation of FU_A₂ to the candidate node. This is shown in FIG. 10. The unit is not used within the contention set so no latency adjustment 1001 is required. This leads to a graph height of 7. Since this is lower than the previous allocation then it is selected in preference.

Transport Adjustment

A further layer of adjustment may be performed on the arcs associated with the node being allocated. The principle is to add additional latencies to inflow and outflow arcs that reflect the likely transport costs. This is done by examining the connectivity distance to the units that communicate with the one which is being allocated. For each arc there is a distance below which the cost adjustment is considered to be 0. This is the maximum direct connectivity distance (a general optimisation constant). If the Euclidian distance is below that then no adjustment is added, otherwise the adjustment is the Euclidian distance minus the zero cost distance. If the producer/consumer unit is fixed then the exact position of the target is known. If the producer/consumer is unallocated then the closest unit of the appropriate type is used. The transport cost adjustment has the maximum impact on the most critical arcs to and from a node. This mechanism attempts to allocate units within dusters that have appropriate local functional units.

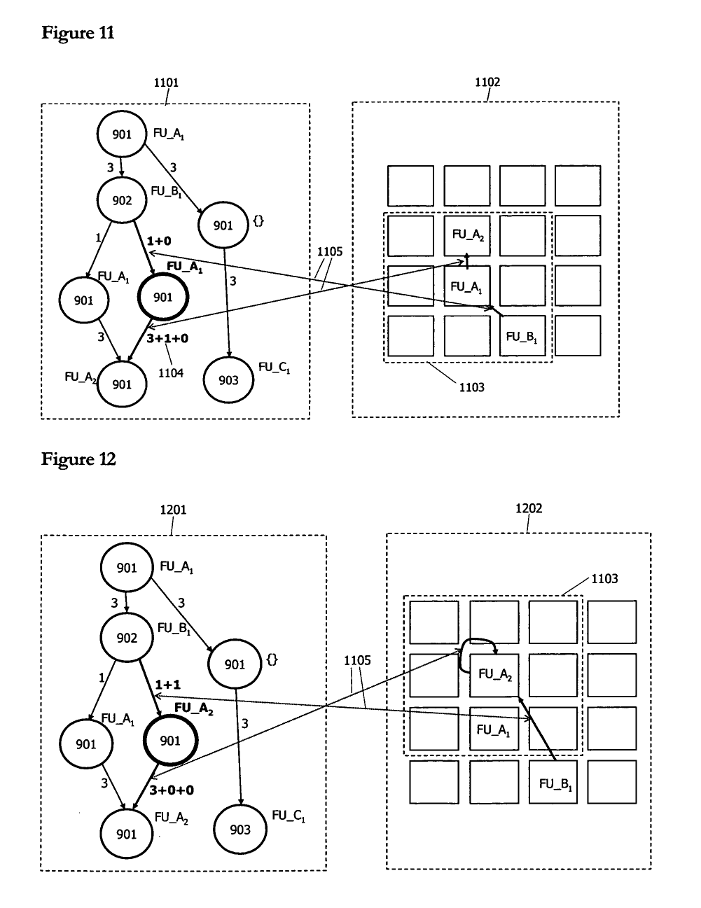

FIG. 11 shows an example transport adjustment The original CDFG is shown as 1101. The spatial layout of the processor 1102 is shown. The candidate allocation is to unit FU_A₁. The area 1103 indicates where transport to the unit FU_A₁ is considered to be “free” as there could be direct connections. Transport outside of that area has an associated cost. The inflow and outflow data arcs for the candidate node are examined with respect to the physical layout 1105. The output flows to FU_A₂ 1104 that is within the zero cost zone. The input is from FU_B₁, also within the zero cost zone. Thus no transport cost adjustments need to be made and the graph height remains as 7.

FIG. 12 shows an alternative allocation for the node. The area 1201 represents the original CDFG. The area 1202 represents the physical layout of the architecture. The node has been allocated to functional unit FU_A₂. The outflow arc is to the same node again so is within the zero cost zone. The input, however, is from node FU_B₁ which is outside the zero cost zone. The corresponding arc is thus augmented which an additional latency of 1 clock cycle. This represents the distance of the unit outside of the zero cost zone. The additional latency increases the graph height to 8 clock cycles. Thus the previous allocation is selected in preference to this one.

Transport Allocation (Step 306)

Transport allocation is performed as a transformation on the CDFG. Its goal is to bind each data arc in the graph onto a physical communication resource in the target architecture. This can be done in such a way that the CDFG always remains acyclic. If there is a direct connection between the result port of the unit and the required operand then no additional operations are required. In other cases addition copy operations are generated to transport the data item to the required operand. A search is performed from the output to all connected nodes to find the best route to the destination operand. The route with the shortest latency is always chosen.

On each occasion an operation is added to the CDFG (including copy operations) addition arcs may be added to force an order on the use of the associated output register. This forces a serialisation on the use of the output register resources and prevents live data values from being overwritten. The register resource structure is used for this purpose (it is also used to provide ordering on main register accesses). When an operation is generated dependency arcs are added to all previous readers of the output register. The new write forms a new live range for the register that is held in the register resource structure. This ensures that the operation is not scheduled until all previous reads of the previous value are complete. The arc latency may be negative as the writing operation may commence before the read has completed. It must happen before the output register is overwritten at the end of the pipeline.

The constructed CDFG describes the operations in the original source program and the dependencies between them. However, the CDFG must also be extended to incorporate data transports between operations. Unlike traditional processors, the preferred embodiment processor is not a fully connected machine. Thus data items cannot be arbitrarily copied from one functional unit to another. If a bus does not directly connect two functional units then additional operations must be generated to move the data item. The connection has to be between the output result port of one functional unit and the input operand port of another. These additional operations must be scheduled like any other operation that is to be run on the processor.

The additional nodes are called copy operations. They simply copy the input of a functional unit to its output without performing any operation. Certain functional units are able to operate in copy mode whereby a particular input operand is selected and copied to all the result ports. The latency of such a copy operation is identical to that for ordinary operations performed by the unit, in order to simplify the scheduling problem when handling a mixture of both real and copy operations on a unit. The transport allocation algorithms choose a particular route that is to be taken by a data item from the source to the destination, generating copy operations on the intervening functional units. During the transport allocation the route chosen is fixed and always represents a route with minimum latency through the connectivity network.

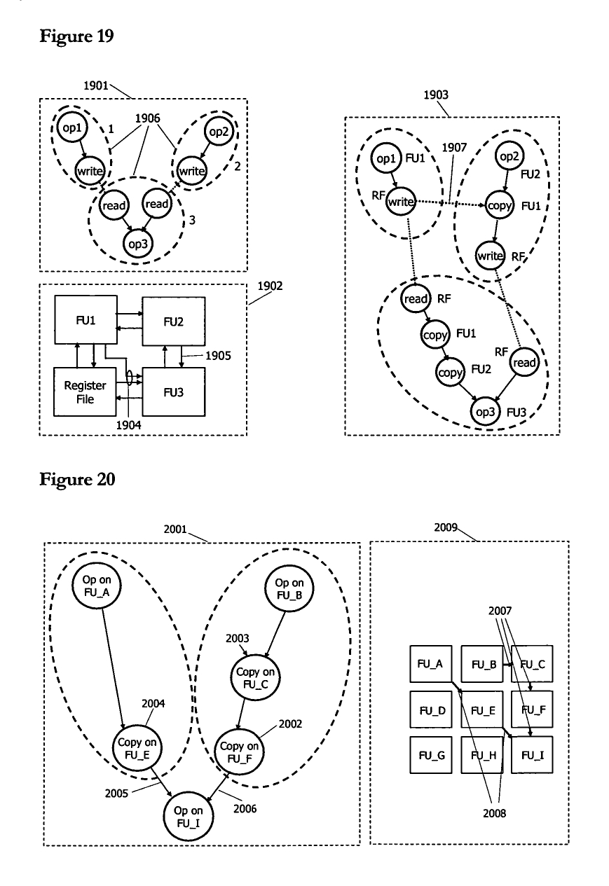

Transport allocation is performed as a step after the initial CDFG construction. For illustrative purposes, FIG. 19 shows an example CDFG without and then with transport operations added. The architecture of the simple example processor is shown as 1902. As can be seen the functional units are not fully connected and this requires the use of some transport allocation copies. The CDFG 1901 shows the nodes as generated from three different source instructions before transport allocation. The dusters of nodes 1906 associated with particular source instructions are shown. The first two perform an operation and write the result back to the register file. The last instruction reads those registers and performs another operation. The operations are not bound to particular functional units at that stage.

The area 1903 shows the same CDFG with the required copy operations added. The op1 is bound to FU1 that can write directly to the register file. Thus no copy operation is required. The op2 is bound to FU2 that is not connected to the register file. A copy operation through FU1 is added. The copy is dependent on the completion of the earlier register file write (i.e. the consumer of the last use of the register in FU1). Thus the copy cannot be completed until the previous use of the output register has been completed. Register ordering dependencies 1907 prevent the register file reads being scheduled earlier than the register file writes. Two copy operations are required to move the required data to the first operand of FU3 shown as 1905. The other operand to FU3 shown as 1902 can be sourced from either FU1 or the register file.

In general it cannot be assumed that it is possible for the results from a register file read to be directly accessible by the functional unit that is to perform the instruction operation. That is, the units may not be directly connected Thus whenever data must be transferred between arbitrary functional units some transport allocation may be required.

FIG. 20 shows an example of transport allocation. The source CDFG is shown as 2001. When the operation on FU_A is added to the CDFG a copy operation is also added to move the result to the appropriate operand input of the FU_I operation. The area 2009 shows the spatial layout of the processor. An operation in unit FU_I needs to be performed on results generated from units FU_A and FU_B. Firstly the output of the operation performed on FU_A needs to be transported to the left hand 2005 input of the unit FU_I. The most direct path between FU_A and FU_I is shown as 2008. This requires the insertion of a copy node 2004 to indirectly copy data through FU_E. Secondly the output of the operation performed on FU_B needs to be transported to the right hand 2006 input of FU_I. The most direct path between FU_B and FU_I is shown in the architecture as 2007. This requires the insertion of two copy operations 2003 and 2002 to transport the data from FU_B to FU_I. The dependencies are added in the original sequential order of the code and thus the additions are guaranteed to maintain an acyclic graph.

Transport Optimisation (Step 307)

The output from the code translation process is an unoptimised CDFG. All register reads and writes in the host architecture are translated into register file read and write operations in the CDFG.

The transport optimisation pass visits each of the arcs in the CDFG to allocate them a new route if that can improve parallelism. The optimisation is done in order of arc criticality with the most critical paths being optimised first. Critical path analysis is redone after each change to the allocation but any single arc can only be optimised once. This ensures that the most critical paths are given the first choice of transports. The complete path through copy operations is considered to be a single path for optimisation purposes (as the optimisation aims to change the copy operations).

An optimised CDFG is only valid if the new arcs can be added with causing the graph to become cyclic. A matrix is generated showing the transitive closure of the CDFG. When a new arc is added a test is made to see if it makes the graph cyclic.

Before a new optimisation is attempted the existing one is checkpointed. This checkpointed CDFG state can be returned to should the optimisation result in a cyclic graph. It is reinstated if no better path can be found. The finding of legal paths is a complex optimisation problem with an extremely large search space so a number of heuristics are employed. The basic scheme is to perform a depth first traversal of all routes forward from the result port. At each stage an attempt is made to use a direct route from the producer to the consumer. Visit flags are maintained so that no attempt is made to follow the same route more than once during the traversal.

At each stage (including the initial output from the producer) the output register write has to be inserted into the live range for the register. An insertion attempt is made at each point. As the write is inserted the appropriate arcs are added to ensure that the write occurs after previous reads and the reads and performed before the next write. If that leads to deadlock then the insertion point is discarded. Once all insertion points are attempted then the one with the one leading to the lowest graph height is selected. If there are multiple insertion points leading to the same graph height then the one with the greatest average slack is chosen. If no insertion points are possible then the route is abandoned.

The goal of the optimisation process is to remove unnecessary operations and dependencies between operations, in order to improve scheduling freedom. Primarily, the transport optimisation process seeks to remove many of the register file accesses. If data is written to a register and subsequently read by a later operation then, in many cases, the CDFG can be rewritten so that data is passed directly from one operation to the next. If a register is not live at the end of a strand then in many cases it is possible to completely eliminate the register write. These optimisations reduce the amount of bandwidth required to the register file and to make use of direct connectivity between execution units. Using such direct connectivity can significantly enhance performance.

This optimisation process can, in a sense, be viewed as the implementation of the front end of a high end microprocessor in software. High end processors are able to perform dynamic instruction re-ordering and register renaming. Unfortunately, these facilities come at a considerable cost in terms of area, power and design complexity. The preferred embodiment statically analyses code and reorders operations in an efficient manner. Many accesses to the register file are optimised away to use direct paths between execution units, equivalent to the complex network of feed-forward buses in a high end processor. The hardware of the preferred embodiment remains simple and is controlled directly from a closely coupled execution word with the minimum of decode overhead.

The CDFG optimisation process elucidates the data flows between functional units in the architecture. These data flows may then used during the architectural optimisation process to direct the connectivity between the functional units. If a particular data flow appears commonly, or in a particularly critical block of code, then this will in all likelihood lead the architectural optimiser to create a connection bus that corresponds to the data flow.

Register Promotion

Register promotion is an important optimisation that helps to reduce register file bandwidth pressure. In many cases a particular register may be read several times while holding the same value. This corresponds to the host code using the same register operand a number of times. If there are no intervening writes to the same register then all the reads will obtain the same value.

The purpose of the optimisation is to reduce the number of register reads so that only a single read is performed. The data obtained from the read may then be passed to all the operations that use the value. The data can be transported to the required operands over the connectivity network.

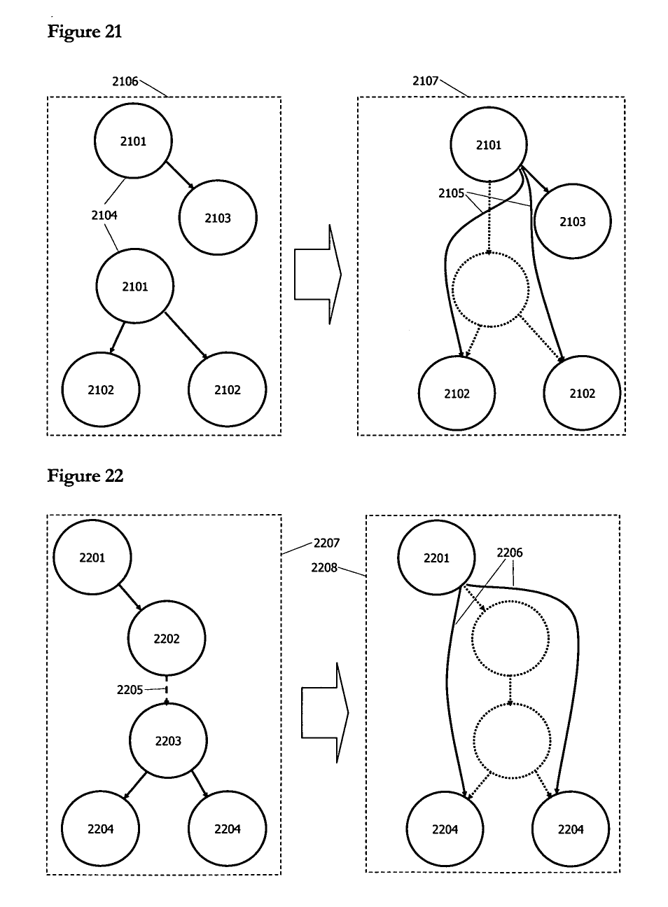

FIG. 21 illustrates the register promotion optimisation. The area 2106 shows a segment of the CDFG prior to the optimisation. There are two read 2101 operations from the same register. The first read has a single consumer of the data 2103 and the second read has two consumers 2102. There is an association between the two reads as they are guaranteed to obtain the same value from the register file.

The area 2107 shows the CDFG segment after optimisation. The second read operation 2101 has been deleted as it is redundant The data obtained from the first read is routed 2105 to the consumers of the second read.

In general this optimisation can only occur if the reads are all in the same strand. However, in some circumstances the optimisation can be applied to accesses from different strands. The first read must be in a strand that is an atomic pre-dominator of the subsequent reading strands. That is, if the first read is executed then all subsequent reads are performed during the same execution of the region.

Register Bypassing

Register bypassing is another important optimisation that allows the elimination of both a register write and a subsequent read. The register promotion and register bypassing optimisations can be applied to the same segment of the CDFG, forming synergistic optimisations.

The optimisation occurs when a particular data item is written to a register and then subsequently read back within the same strand. The CDFG is rewritten so that the data passes directly from the data producer to the eventual consumers without having to pass through the register file at all. This optimisation can be on many occasions in typical code. Sequences that write to a register and subsequently read from it in the next instruction or within a few instructions in the same basic block are extremely common. In traditional processor architecture, reads of results in the next instruction would use a feed forward path around the register file. This optimisation represents a type of software equivalent to this construct.

Operation sequences are explicitly rewritten to use direct scheduled paths through the connectivity network rather than the register file.

FIG. 22 illustrates a register bypassing optimization. The area 2207 shows a segment of a CDFG before the optimisation. Data is calculated 2201 and then written to a particular register by a register write 2202. The data is accessed by a register read 2203 and then passed to two consuming operations 2204. A tunnel arc 2205 links the register write 2202 and register read 2203. This indicates that data is “tunneling” through the register file and that the read definitely obtains the data stored by the write.

The area 2208 shows the CDFG segment after optimisation. Both the register write 2202 and read 2203 are deleted. The original data producer 2201 passes its output to the data consumers via data arcs 2206, completely avoiding the register file.

In general this optimisation can only occur if the write and read are in the same strand. However, in some circumstances the optimisation can be applied to accesses from different strands. The write must be in a strand that is an atomic pre-dominator of the subsequent reading strand. That is, if the writing strand is executed then the reading strand must also be executed during the same execution of the region.

If the register is live at the end the strand then the register write cannot be deleted. In that case the bypass to the original data producer can still occur by the register write operation remains.

This optimisation allows greater scheduling freedom since the data consumers can be scheduled as soon as the data is available and the write can be scheduled later as it does not impact the placement of the consumers.

Live Range Insertion

Alongside the CDFG a separate data structure is maintained. This maintains the definition and use information for each output register within the architecture. The definition shows the node in the CDFG that generates a value in the register and the use chain shows the nodes that consume that value. The point of the definition of the register to the issue of the last consumer of its value is its live range. Lives ranges for a particular register cannot overlap as all consumers for a particular value must be issued before a new definer can. If this rule is not observed then invalid results will be obtained.

As transport optimisation is performed, particular live ranges may be deleted and new live ranges inserted. The appropriate arcs in the CDFG must be deleted as a live range is removed and new arcs added as a new live range is inserted.

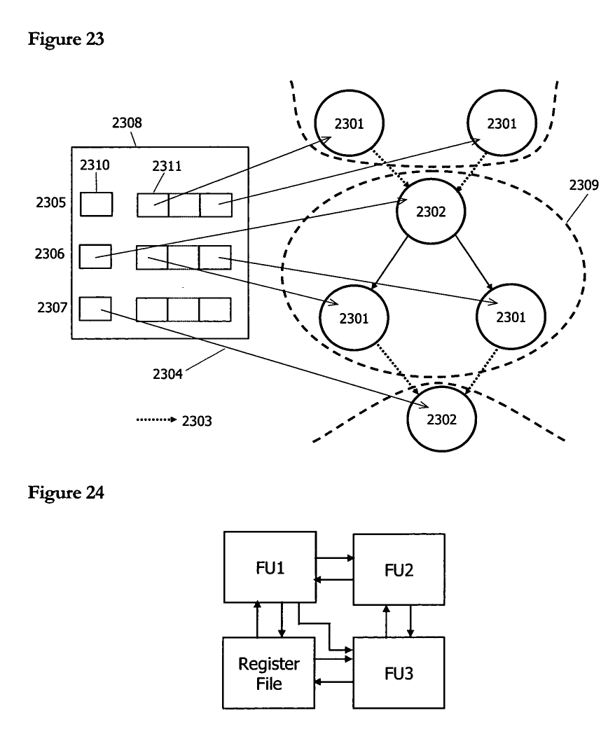

FIG. 23 shows the duration of live ranges for a particular register with a new live range being inserted into the CDFG. The area 2308 shows both producer and consumer entries in a table. Each row 2305, 2306 and 2307 shows the information for a given live range for a register in the architecture. The area 2310 shows the defining node 2302 for the register. The area 2311 lists all the consumers 2301 of that particular value.

The consumers for the live range 2306 are shown in the area of the CDFG 2309. Dependencies 2303 are generated to the producer for the live range so that the register is not overwritten before all the consumers have read the data. The latency of the control arc is 1—(the latency of the producer). Thus if the producer has a latency longer than 1 then the consumers might actually be issued after the producer. However, the dependency guarantees that the consumers will have read the data before the producer overwrites the register with a new value.

Data arcs connect the producer to the consumers. Finally the consumers of in the new live range have control arcs to the producer of the next live range.

Path Optimisation

This section describes the process of path optimisation. The optimisation is based around the example architecture shown in FIG. 24. As can be seen there is not full connectivity between all functional units so additional copy operations have to be inserted for certain data transports:

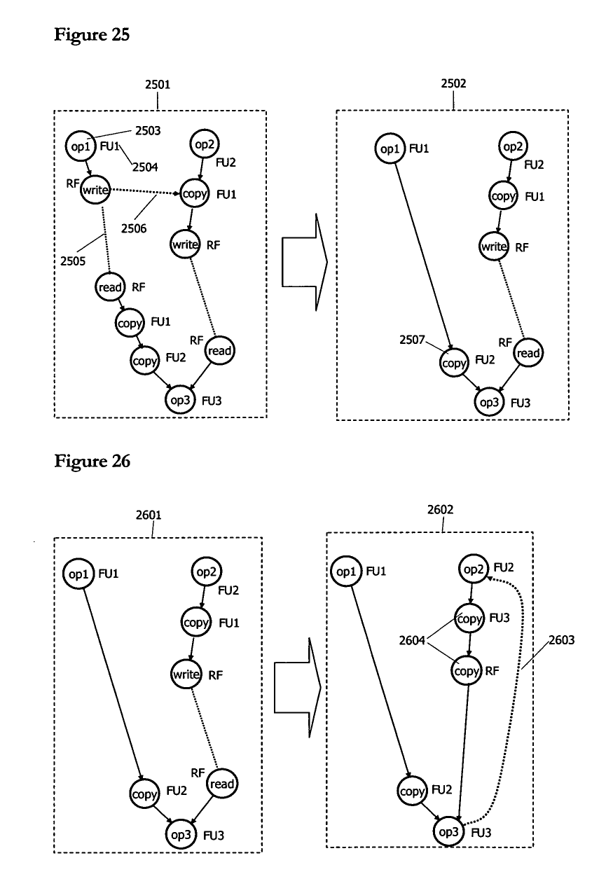

FIG. 25 shows an initial CDFG 2501 and then an optimised CDFG 2502. The allocation of particular nodes 2503 to functional units 2504 is shown. Arc 2505 is a tunnel arc between the write and read of the same register. Arc 2506 is a dependency required due to the liveness of the output register of FU1. The example is identical to that used in the description of the initial transport allocation performed during the initial CDFG construction. Optimisations are performed in order of arc criticality so it is assumed that the arcs from op1 to op3 are more critical than those from op2 to op3. This is because there are more transport operations and thus greater latency in the former path. A register bypass operation is performed between op1 and op3. Since FU1 result (where op1 is mapped) and FU3 left operand (where op3 is mapped) are not directly connected a new copy operation 2507 is required. This is performed on FU2 to copy the result to the left operand.

The next step is to try and optimise the transport between op2 and op3. This is shown in FIG. 26. The CDFG updated with the previous optimization is shown in the area 2601. The area 2602 shows a register bypass optimization to eliminate the register write and subsequent read (it is assumed that the register is not live after the read usage). Since FU2 result (where op2 is mapped) and FU3 write operand (where op3 is mapped) are not directly connected then additional transport copy operations 2604 must be added. One possible route is via FU3 and RF and this is inserted into the CDFG. Thus the data is initially transported from FU2 to FU3. This is the same route that is being used to transport the other operand to op3. The live range insertion of the transport is after that for the transport for the left operand. Thus a dependency arc 2603 from op3 (the last consumer for the previous use of the register) to op2 is added. However, this leads to a cycle in the graph. This is detected by forming the transitive closure of the graph. All graph additions that lead to a cycle graph are illegal and the particular transport optimisation is abandoned.

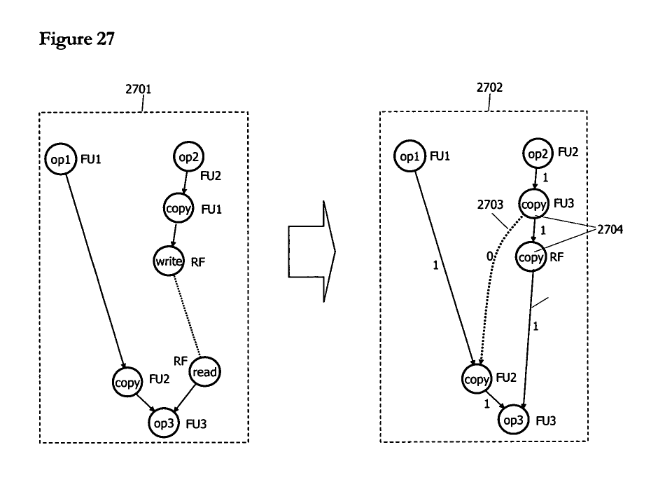

A further attempt is made at the same transport optimisation. This is shown in FIG. 27. The CDFG is shown as 2701. Another possible optimization is shown in the area 2702. The same copies 2704 as required previously are used. In this case the live range insertion is performed before the usage for feeding the left operand of op3. This leads to a dependency 2703. In this case the optimisation maintains an acyclic graph and is legal. The new graph height is measured and found to be 3 clock cycles.

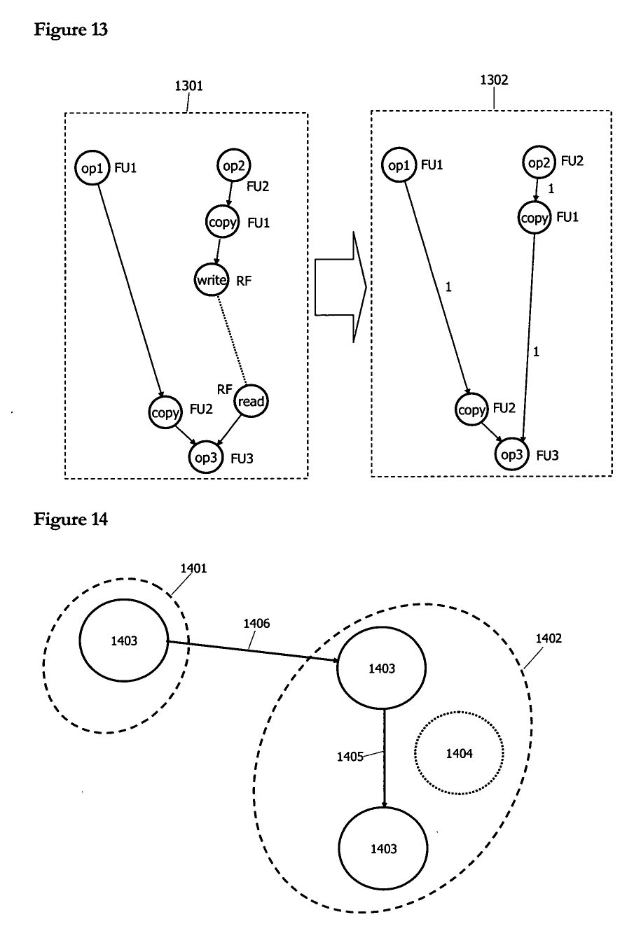

Finally a different transport route for the right operand of op3 is tried. This is shown in FIG. 13. In this case the data is transported counter-clockwise around the architecture to FU1 and then directly to the right operand of FU3. Since this only requires a single copy operation it results in a graph height that is lower than that for the previous routing. Thus this is chosen in preference.

By choosing arcs for optimisation in order of their criticality, the most important data flows in the code are given the best choices of routes through the connections available in the architecture.

Execution Word Optimisation

An example execution word is shown in FIG. 2. The execution word 205 is divided into three sections, each occupying contiguous bits in the word:
End Bit This area 202 is a single bit used for specifying the end of the region. The bit is set for the last execution word in a region.
Opcodes: This area 203 is a block of bits that are used to specify operation codes for enabling particular functional units. Individual sections 201 control particular groups of functional units. There are specific opcode bits for each group within the instruction groups section.
Instruction Groups: This area 206 is the block of bits that actually control the individual functional units. The section is divided into a number of individual opcode blocks. The size of these groups is dependent upon the number of bits required to control particular functional units.

The diagram shows the required opcode bit values 207 to enable the use of a particular functional unit. This value is compared against the bits set in the opcode section. If there is a match then the functional unit is enabled. Only one functional unit from each instruction group may be enabled in each execution word. The opcode pattern 0 is reserved for each instruction group to specify a NOP (No Operation). If that pattern is used then no functional unit is enabled for the group. The functional units 204 are shown immediately below the group of bits 201 that are used to control them.

An optimisation process determines the number of instruction groups and their widths automatically. In general, the most frequently used functional units are allocated into separate groups. This allows these units to be used simultaneously. Thus restrictions on parallelism due to layout interference between different functional units are minimised. Some functional units need a representation that uses more bits than can be specified in any one instruction group. In that case two or adjacent instruction groups may be used for the unit. The opcode sections for the groups are also combined and a unique opcode value is used from each individual group.

The number of bits required for each functional unit is dependent on a number of factors. Firstly, the method needs to be specified. The number of bits required is dependent upon the number of individual methods for the unit. In some cases the method operand is also used for specifying immediate values. The remainder of bits are used to control the multiplexers for each operand. The number of bits required for each operand is dependent upon the number of sources that are selectable for the multiplexer.

Since the number of bits required for each individual functional unit differs, some bits may be unused within the instruction group depending on the unit selected. These unused bits are simply cleared.

Each functional unit only needs two contiguous groups of bits from the execution word to control it. Firstly, there is the opcode bus formed from one or more opcode sections in the execution word. Secondly, there is the instruction bus formed from one or more instruction groups in the execution word. This allows a simple specification of the connectivity required for a particular functional unit in structural HDL.

The placement of the control and opcode bits in the execution word for each functional unit are written out to the processor definition file during the synthesis process. This is file is read when generating code for the architecture so that the correct execution word layout can be generated.

It is understood that there are many possible alternative embodiments of the invention. It is recognized that the description contained herein is only one possible embodiment. This should not be taken as a limitation of the scope of the invention. The scope should be defined by the claims and we therefore assert as our invention all that comes within the scope and spirit of those claims.

1. A method of generating executable code for a configurable microprocessor architecture whereby:
there are individual registers in the data paths between execution units;
the update of these registers is explicitly managed from the instruction set of the processor; and
the reading and writing of those registers is represented in a data flow graph representation of the program being targeted to the processor.

2. The method according to claim 1 whereby the number of registers associated with particular execution units is configurable.

3. The method according to claim 1 whereby the target architecture is specified in an input file.

4. The method according to claim 1 whereby certain units may only be connected to a subset of other execution units in the architecture.

5. The method according to claim 4 whereby there is a central register file but only a subset of the execution units in the system can directly communicate with it.

6. The method according to claim 3 whereby the input program is initially represented as a sequence of operations that can be performed by execution units present in the target architecture.

7. The method according to claim 6 whereby the inputs to and results from these basic instructions may be communicated via a central register file.

8. The method according to claim 7 whereby the code sequence may be optimised to reduce the communication required with the central register file.

9. The method according to claim 8 whereby multiple reads of a given register file value may be transformed into a single read with suitable communication of the same data to other consumers of the data value.

10. The method according to claim 8 whereby pairs of central register file writes and reads may be transformed to use direct communication between the generating and consuming operations.

11. The method according to claim 1 whereby the data flow graph is transformed so that data edges correspond to physical connections in the architecture.

12. The method according to claim 11 whereby additional nodes may be inserted into the graph to represent the copying of data values where there is no physical connection corresponding to the graph data flow.

13. The method according to claim 12 whereby the dependencies between reads and writes to registers are represented as edges in the graph.

14. The method according to claim 13 whereby graphs that cannot be scheduling are detected by the presence of cycles in the graph.

15. The method according to claim 1 whereby an idealised form of the graph is generated that assumes the availability of unrestricted connectivity in the architecture.

16. The method according to claim 15 whereby the idealised form of the graph is used to influence the binding of operations to physical execution units in the architecture.

17. The method according to claim 1 whereby special edges within the graph represent communication of data via a central register file.

18. The method according to claim 17 whereby operations from different basic blocks may be represented in a single graph.

19. The method according to claim 1 whereby individual operations in the graph are bound to particular execution unit instances.

20. The method according to claim 19 whereby the unit binding uses an estimate of the delay caused by transporting operands to and results from the operation as a factor in the allocation.

21. The method according to claim 20 whereby the transport cost is dependent on the structure of connectivity between the operations in the graph.

22. The method according to claim 1 whereby the graph may be updated as new physical paths are added to the architecture in order to reduce the graph height to allow shorter code schedules.

23. The method according to claim 1 whereby individual execution units are controlled by particular bits within the overall execution word.

24. The method according to claim 23 whereby certain bits in the execution word may be used to control more than a single execution unit.

25. The method according to claim 24 whereby the allocation of bits in the execution word to particular execution units is optimised as the architecture is generated.

26. The method according to claim 25 whereby the usage of individual execution units is used to influence the allocation of the execution word.

27. A microprocessor configured to execute code that has been generated using the method of claim 1.
